(19) United States
(12) Patent Application Publication
(10) Pub. No.: US 2009/0228897 A1
(43) Pub. Date: Sep. 10, 2009

(54) Bidirectional Control of Media Players

(76) Inventors: Frank H. Murray, Greenwich, CT (US); Eric Paul Schencman, Rockville Centre, NY (US)

Correspondence Address: BROMBERG & SUNSTEIN LLP, 125 SUMMER STREET, BOSTON, MA, 02110-1618, US

(21) Appl. No.: 12/398,106

(22) Filed: Mar. 4, 2009

Related U.S. Application Data
(60) Provisional application No. 61/033,575, filed on Mar. 4, 2008.

(51) Int. Cl. G06F 9/44

(52) U.S. Cl. 719/313

(57) ABSTRACT

Systems, methods, and computer program products for bidirectional control between two or more media players. A first media player is launched on a computer system either manually or automatically. A second media player is subsequently launched. Inter-process communication is established between the first and second media players. The second media player determines if the first media player is playing first media content. If the first media player responds affirmatively, the second media player sends a command via the inter-process communication to the first media player to stop playing. The first player responds to the request from the second player by stopping playback. The second media player then begins playback of a second media content. After the second media content stops playing, the second media player informs the first media player, and the first media player returns to playing the first media content.

### PRIORITY

This application claims the benefit of U.S. Provisional Application No. 61/033,575, filed Mar. 4, 2008, which is incorporated herein by reference in its entirety.

### FIELD OF THE INVENTION

The present invention relates to media players and more specifically to media players controlling the playback of other media players.

### DESCRIPTION OF RELATED ART

It is known in the prior art to have a media player either embedded in a web page or as a separate application launched when accessing a web page that streams media content from a server. When a user is listening to streaming content, the user may navigate to another web page or link and launch a second stream in a separate media player. Similarly, the user may navigate away from a standalone media player and access content through a separate media player associated with a web page. In these situations, both media players will produce audio and/or video output simultaneously. In order to avoid both media players outputting content at the same time, the user must locate the instance of the media player that the user wants to stop and then the user must actively select the stop function within that media player.

### SUMMARY OF THE INVENTION

Systems, methods, and computer program products for bidirectional control between two or more media players operating on a computer system is disclosed. A first media player is launched on the computer system either manually or automatically. A second media player is subsequently launched. The media players may be launched based upon a request for a web page. A script may be present within the web page that launches one of the media players. A socket connection on the computer or other inter-process communication is established between the first and second media players. The second media player checks to see if the first media player is playing first media content. If the first media player responds that first media content is playing, the second media player sends a command via the socket connection/inter-process communication to the first media player to stop playing. The first player responds to the request from the second player by stopping playback. The second media player then begins playback of a second media content. After the second media content stops playing, the second media player informs the first media player, and the first media player returns to playing the first media content.

The communication between media players can be expanded to three or more media players, such that a priority is assigned to each of the media players or the media content. Thus, when a first media content ends, the media players may communicate and determine the next media content for playback based upon the priority. Priority can be assigned based upon the order that the media players were launched or based upon another criteria set.

In a first embodiment of the invention there is provided a method for controlling media players operating on a computer system. The method begins by establishing an inter-process communication between a first media player and a second media player, and in the second media player, determining if the first media player is playing first media content using the inter-process communication. If the first media player is playing the first media content, the method requires sending a command via the inter-process communication to the first media player to stop playing, and starting playback of second media content on the second media player. The media players may be standalone applications, embedded in a web page, or launched as an application within a web page container.

The method may be extended by stopping playback of the first media content in the first media player after receiving the command from the second media player. Or it may be extended by sending a begin playback command to begin playback of the first media content, from the second media player to the first media player via the inter-process connection, when the second media content stops playing.

The method may also be extended by launching on the computer system the first media player, starting playback of a first media content on the first media player, and launching a second media player on the computer system. Launching the second media player may occur as the result of requesting a web page, in which case the second media player may be embedded within the web page. Or, launching the second media player may occur as the result of user interaction with a web page. For example, the second media player may be launched as the result of a script within the web page, in which case the script may cause a container to be created, with the second media player being within the container.

A related method provides for maintaining a priority among the media players and launching a third media player. The third media player takes several actions, including establishing an inter-process communication with the first media player, establishing an inter-process communication with the second media player, and communicating with the first and the second media players through the connections to coordinate playback based upon the priority.

There is also provided a computer program product comprising a tangible computer-readable medium for use with a computer system, the computer-readable medium having program code thereon for controlling playback of media content on a first media player. The computer code includes code for establishing an inter-process communication with the first media player and for determining if the first media player is playing first media content. It also includes computer code for sending a command via the inter-process communication to the first media player to stop playing if the first media player is playing the first media content, and computer code for starting playback of a second media content.

The computer program product may have, in related embodiments, computer code for sending a begin playback command to the first media player via the inter-process communication to begin playback of the first media content when the second media content stops playing. The first media player may be embedded within a web page. The computer program product may also have computer code for maintaining a priority among the media players and coordinating playback between the media players based upon the priority.

There is also provided a system for controlling a media server. The system includes a speaker, a video display, and two media players. The first media player is adapted to connect to the media server to control the reception of audio or visual data from the media server, display audio or visual data retrieved from the media server on the speaker or video display, respectively, and communicate with other media players using inter-process communication. The second media player is adapted to display audio or visual data on the speaker or video display, respectively, and to communicate commands to the first media player, using inter-process communication, for directing the first media player to control the reception of audio or visual data from the media server.

In related system embodiments, the first and second media players each may be a standalone media player or embedded in a web browser displayed on the video display. The first media player may be within a first computing device while the second media player is within a second computing device. Further, the first media player and the second media player may be adapted to avoid simultaneous playback of audio on the speaker or video on the video display by communicating with each other using inter-process communication.

In other related system embodiments, the reception of audio or visual data from the media server may include the reception of data according to a playlist, and the second media player is adapted to direct the first media player to select the next media in the playlist for playback, select the previous media in the playlist for playback, load the playlist, save the playlist, add media to the playlist, or remove media from the playlist. In such related embodiments, the media server may control the playlist, and the second media player does not have permission to modify the playlist.

In yet another embodiment, a method for controlling a media server is provided. The method includes a first media player connecting to the media server and requesting transmission of a stream of first media data, then receiving the stream of first media data and playing it. Meanwhile, in a second media player, using inter-process communication, the method involves sending the first media player a command to stop receiving the stream. The method then has, the first media player, as a result of receiving the command, directing the media server to stop sending the stream and the second media player playing second media data.

A related method embodiment has the second media player using inter-process communication, sending the first media player a second command to resume receiving the stream of first media data, then stopping the play of the second media data. This related embodiment then has the first media player, as a result of receiving the second command, connecting to the media server and requesting transmission of the stream of first media data, receiving the stream of first media data, and playing it. The second media player may send the second command in response to a user request, reaching the end of the second media data during playback, or reaching a certain date or time during playback.

### BRIEF DESCRIPTION OF THE DRAWINGS

The foregoing features of the invention will be more readily understood by reference to the following detailed description, taken with reference to the accompanying drawings, in which:

FIG. 1 shows an environment for embodying the present invention that includes an Internet browser and two media players as represented on a display of a computer system;

FIG. 2 is a flow chart of the bidirectional communication between two media players;

FIG. 3 is a block diagram of the relevant functional components of one embodiment of the invention;

FIG. 4 is a block diagram showing three media players in one embodiment of the invention, indicating the priority among the players;

FIG. 5 shows a timing diagram indicative of the media player priorities of FIG. 4; and

FIG. 6 is a block diagram of two clients coordinating to control two servers.

### DETAILED DESCRIPTION OF SPECIFIC EMBODIMENTS

Definitions. As used in this description and the accompanying claims, the following terms shall have the meanings indicated, unless the context otherwise requires. The term “media player” indicates a computer program that functions for the purpose of displaying digital audio or video content, and by extension a graphical interface to such program. A media player may be embedded within a visual container on a computer display, such as a web page, or a media player may be a standalone program. The term “playing” means that a media player is outputting digital data to either a display and/or a speaker. The term “stopped” means that the media player is not outputting digital data to either a display and/or a speaker. “Inter-process communication” refers to any method or implementation known in the art for communicating data between two computer processes, including without limitation sockets (local and network), semaphores, shared memory, message queues, and signals.

A user may experience a computer or other system running several media players at the same time. In embodiments of the present invention, these media players coordinate media playback control with each other using bidirectional communications, so that only one media player plays media at a given time. The media players may establish a priority for playback, and only the player with the highest priority may play. When the highest priority player finishes, the system may remove this media player from the priority list, and allow the media player with next highest priority to play. In this way, only one media source plays at any time. Additionally, the media players will respond to user interactions and user interactions will be assigned the highest priority.

The multiple media players may use the bidirectional communications to direct each other when to begin playing, and when to cease playing, as part of a coordination and control protocol between media players. In some embodiments of the present invention, a media player may further employ the protocol to control a media server to which it is not directly connected. Generally, this indirect control may be accomplished by interacting with a media player in direct communication with the target media server, and commanding it to perform a function with that media server. For example, when a media player having a higher priority communicates with a media player having a lower priority and sends a message indicating that the media player with the lower priority should cease playback, the media player with the lower priority will communicate with the media server that it is in communication with and inform the media server to cease streaming the media content or pause a download. Thus, the higher priority media player may control the media server that is in communication with the lower priority media player.

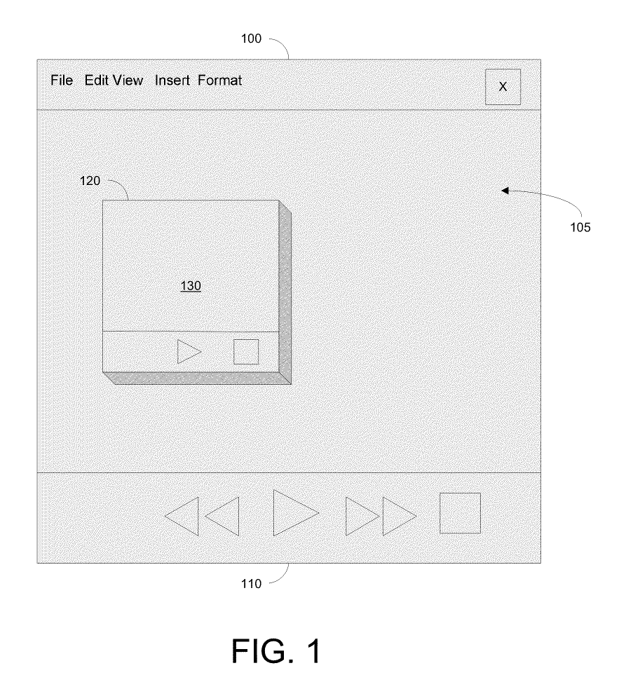

FIG. 1 shows an environment for embodying the present invention on a user's computer system that includes an Internet browser 100 and two media players 110, 120. A user requests a web page 105, such as an HTML (hypertext markup language) or PHP (hypertext preprocessor) web page, through a request transmitted by the user's computer system via Internet browser 100. The web page 105 contains text (not shown) and an embedded media player 110. The web page 105 may contain instructions to embed a second media player 120 in the browser 100, or to launch media player 120 in another window. Media player 120 may be automatically launched by a script in web page 105. The media player may or may not require user input to initiate playback of audiovisual data. The media players 110, 120 may be implemented using a programming language, for example, C, Flash, Java, or another programming language.

In one embodiment, the web page 105 or another web page includes a button that accesses JavaScript on the web page than launches a new window that includes a second media player. In one embodiment, the player is a Flash media player. Internal to the first media player 110 is a script function that opens a an inter-process communication such as a socket connection on the user's local computer. The inter-process communication allows media players 110, 120 to send messages to each other. The first player 110 includes a ‘get connection status’ command for the second media player 120. If the first media player receives a response to this command that the second player is connected, the first player 110 then sends a request to determine if the second player 120 is playing a file or streaming content 130. Upon a confirmation that the second player 120 is streaming content 130, the first player signals to the second player 120 to stop playback. The first player may then begin or resume playback, such that the user will only hear playback of the first media.

In an exemplary embodiment of the invention, a media player may play video, audio, or both. The media player may have several functional components, including without limitation: a codec to convert media data into video or audio for playing; a media controller for starting, stopping, or seeking back and forth within the media, and otherwise controlling the media playing experience; a play list of several different media for sequential play; a list of channels or stations containing media sources; a list of available media sources for playing or inserting into the play list; and a function for playing related media in another media player. Further, the media player may have visible controls to allow a user to direct the action of the functional components. Such controls may include, for example: icons or buttons for starting, stopping, and seeking media; volume bars or knobs; scroll panes; submit buttons; checkboxes; and other controls. These controls may direct user input to the functional components using software commands.

In one embodiment, a media player may be embedded in a web page using hypertext markup language (HTML) or a similar page-description language. A user may navigate to a web site and retrieve the web page for display in her web browser. The browser may then download the media player, or access a previously-downloaded copy of the media player, and initialize it according to techniques known in the art. The media player may then begin to play media, either at the direction of the user or automatically according to the design of the web page. While the media is playing, the user may choose to access other media. For example, while listening to a recorded radio program, the user may choose to listen to a live broadcast of the radio station playing on the Internet. The first media player may cause one or more other media players to launch. The media players, in accordance with embodiments of this invention, may advantageously coordinate between themselves so that only a subset of them are playing media at any one time. In one embodiment, only one of the media players plays media at any one time, thus allowing the user to focus her attention on audio from only one source (and the associated video, if any).

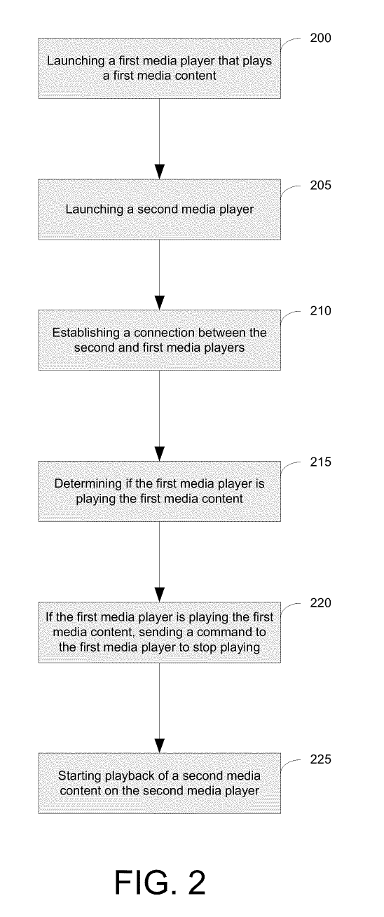

FIG. 2 shows a flow chart of steps taken in establishing communication between two media players. In process 200, a user either automatically or manually activates a first media player on a user's computer system. The media player may be a standalone application, a media player embedded in a web page or a media player that is launched through interaction with a web page. The first media opens a connection and then accesses first media content. The first media content may reside locally or may be located remotely at a server. The first media content is transmitted to the user's computer system or retrieved from memory and the first media player begins playback of the first media content. In process 205, a second media player is launched. In process 210, the second media player connects with the first media player using inter-process communication, such as a local socket connection. In process 215, the second media player then queries the first media player to determine if the first media player is playing content. The first media player may acknowledge that media content is currently being output to the audio device for the computer system. In response to the acknowledgement from the first media player, in process 220 the second media player sends a ‘stop playback’ command to the first media player using the inter-process communication. The first media player receives the stop playback command, and stops processing and transmission of the first media content to the audio device for the user's computer system. In process 225 the second media player begins playback of the second media content.

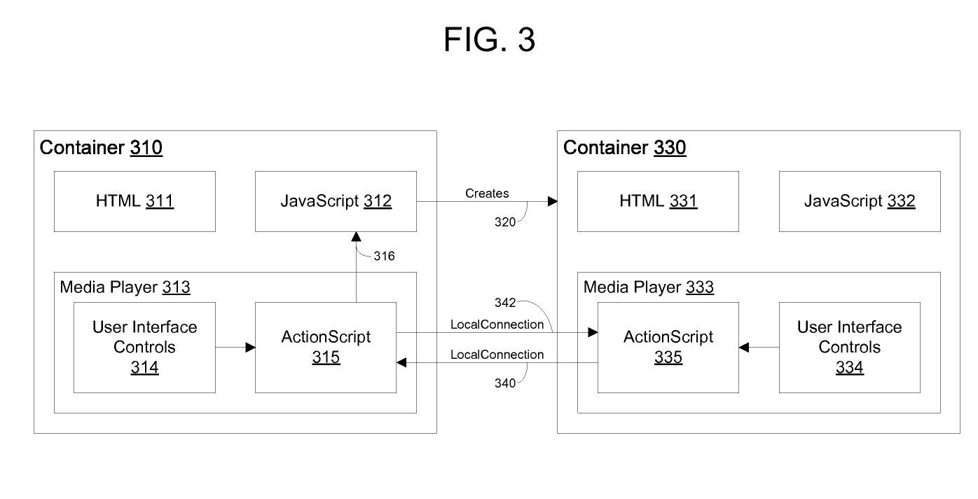

FIG. 3 is a block diagram of the relevant functional components of one embodiment of the invention, which is shown as a Flash embodiment for illustrative purposes. A user may open a container 310 that contains the functional components. Container 310 may be, for example, a web page or an ActiveX control. The container 310 may include HTML 311 which has text, links to images, and document formatting codes. Container 310 may also include JavaScript 312 for providing interactive functionality. In the depicted exemplary embodiment, a media player 313 is embedded within the container 310 using an HTML tag such as <object> or <embed>. Media player 313 may be embodied, for example, as a Microsoft ActiveX control or as a web browser plug-in. The media data to be played in media player 313 may be found in a separate media file, or may be obtained from a data stream. Media player 313 has a user interface, such as that depicted in FIG. 1. This interface may include user interface controls 314, including play, stop, rewind, and advance buttons, a volume slider, and other controls. In various embodiments, user interface controls 314 are monitored. In the exemplary embodiment of FIG. 3, ActionScript 315 performs this function. For example, when a user activates a ‘play’ user interface control, the ActionScript 315 may load a media source and begin to render it to the user's computer display and audio system.

Media player 313 may contain a control for the purpose of launching a secondary media player 333. This control may be a button in the user interface controls 314. When the user activates the launch control, media player 313 calls a particular function within ActionScript 315. An example of this function is presented below. In process 316 the ActionScript function activates a specified function in JavaScript 312. The JavaScript function creates a new window in process 320. The window has a second container 330 to hold the second media player 333. As with the first container 310, the second container 330 may also have HTML 331 and JavaScript 332. The second media player 333 may have its own user interface with user interface controls 334, and ActionScript 335 to provide those controls with functionality.

In the exemplary embodiment, ActionScript 315 and 335 have functions for exchanging messages with each other, examples of which are provided below. ActionScript 335 has a LocalConnection object for communicating with ActionScript 315 in process 340. ActionScript 315 has a LocalConnection object for communicating with ActionScript 335 in process 342. In this way, the two media players 313 and 335 may send each other messages which cause the other player to start or stop playing its media, or cause other desirable effects. Example ActionScript for providing this functionality is given and described below.

However, the scope of the invention is not limited to the above embodiments. A media player may be housed in its own standalone program, rather than embedded in a web page container that has HTML and JavaScript. Also, programming languages other than ActionScript may be used, and the media player need not be a Flash player. For example, the media players 313, 315, or both, and their corresponding user interface controls and control functionality, may be coded in another programming language such as Java, C, or C++, or any other language which includes the ability to display video and audio data to a user and allows one instance (copy) of a program to communicate with another instance of the program or with another program.

Alternate embodiments may launch a second media player using other methods. For example, in addition to, or instead of, a launch button in the media player 313, a web page container 310 may have an HTML link that triggers the JavaScript function, or links directly to the second media player 333. Or, if media player 313 is a standalone program, there may not be HTML 311, or JavaScript 312. A standalone media player 313 may itself launch a second media player 333, using other software functions that may not be available to it as an ActiveX control or when embedded in a web page. In one embodiment, a second media player may be launched independently of the operation of the first media player. For example, a computer user may open a web browser window and navigate to a second web page containing the second media player or a link to the second media player. Or an automatic computer process may launch a second media player at a given time, or in reaction to any event, such as a user initiating a file download. The scope of the invention includes communication between media players, no matter how they are launched.

An exemplary media player is implemented in Flash, and directs user input to functional components using the ActionScript programming language. The following source code demonstrates how the media player may direct a container to launch a second media player to play other media (for example, a live broadcast) in response to a user clicking a button visible in the media player user interface:

import flash.external.ExternalInterface;
...
private var _button:Button;
_button = new Button;
_button.addEventListener(MouseEvent.CLICK,handleClick);
...
private function handleClick(e:MouseEvent) :void {

if (ExternalInterface.available) {

ExternalInterface.call (“openPlayer”);

}

}

This ActionScript code first creates a Flash Button for the user to click, and then registers a function handleClick to be called when the user clicks the button. This function, in turn, checks to see if the Flash player is in a container that accepts commands from the player, and if so, calls openPlayer, a function in the container. By way of example, if the container is a container having JavaScript, then openPlayer is a JavaScript function in the container which takes no arguments. This JavaScript function may open a new browser window and load into it a container containing the second media player, or take any other steps necessary to launch the second media player.

The following ActionScript demonstrates how the first media player may listen for a command to begin playing its media, sent by the second media player using a LocalConnection in process 340:

import flash.net.LocalConnection;
...
private var _playerConnection:LocalConnection;
_playerConnection = new LocalConnection( );
_playerConnection.allowDomain(“*”);
_playerConnection.client = this;
try {

_playerConnection.connect(“first_media_player”);

} catch (error:ArgumentError) {

// failed to connect

}
...
public function startPlaying( ):void {

// start playing the first media player's current media

}

This ActionScript code first creates a new LocalConnection object that allows Flash players on the same client computer to communicate with each other. Then, the media player specifies that it is willing to accept connections from any Flash player, not just one originating from the web site hosting this media player. This optional code allows media players from several different web sites, as well as standalone players, to communicate with the first media player. Next, the code informs the LocalConnection to direct incoming messages to the ActionScript object (class) that contains this code. Finally, it attempts to bind the LocalConnection to the name first_media_player. This name may be used by the second media player to locate the first media player's LocalConnection and send it messages. Binding a name may fail, for example, if another media player has already bound that name. A media player may use this failure condition to determine that other media players are active on the same client computer.

The following ActionScript demonstrates how the second media player may send messages to the first media player using process 340:

import flash.net.LocalConnection;
...
private var _playerConnection:LocalConnection;
_playerConnection = new LocalConnection( );
...
public function startFirstPlayer( ):void {

_playerConnection.send(“first_media_player”, “startPlaying”);

}

This ActionScript code first creates a new LocalConnection object that allows two Flash players on the same client computer to communicate with each other. At a later time, the second media player may require that the first media player start playing. As an example, the second media player may reach the end of its media and finish playing. As another example, the user may activate a control on the second media player to cause it to pause or stop playing. In such cases, the second media player may call the function startFirstPlayer. This function sends a message to the LocalConnection previously bound to the name first_media_player. From the previous code example, this is the first media player. The message instructs the first media player to call the function named startPlaying. As can be seen from the previous code example, this function starts playing the media currently prepared for play in the first media player.

A media player may use an event-driven programming model. Using this model, the media player may respond to events, such as user interaction, that occur at times not known in advance. Typically, in an event-driven model, software objects define various events, and other objects are registered to be notified when these events occur. A media player may have several components that should be notified when a particular event occurs, called event ‘listeners’. For example, when a first media player receives a startPlaying command, it may update its user interface, change its networking behavior, collect statistics, or perform other functions. These tasks may be performed by event listeners. Thus, the following ActionScript demonstrates how a first media player 313 may trigger an event in ActionScript 315:

import flash.events.*;
...
public static const PLAY_BROADCAST:String = “play_broadcast”;
public static const STOP_BROADCAST:String = “stop_broadcast”;
...
public function setStreamingStatus(v:Boolean):void {

if(v == true) {

dispatchEvent(new Event(PLAY_BROADCAST));

} else {

dispatchEvent(new Event(STOP_BROADCAST));

}

}

This ActionScript code first defines two constants, PLAY_BROADCAST and STOP_BROADCAST, which represent the events. When function setStreamingStatus is called, an event object is created and dispatched. If the status is true, then a ‘play’ event is generated, while if the status is false, a ‘stop’ event is generated. This function may be called at an unpredictable time. For example, this function may be called when a user activates a control on the first media player. If the user presses a ‘play’ button in the media player user interface, the media player may call this function. Or, this function may be called upon receiving a command from a second media player in process 340. Once the function is called, it activates an Event, and event listeners may be notified.

The following ActionScript demonstrates how a media player may register event listeners to respond to events generated by the previous sample code, assuming that the code was in an object called PlayerConnection:

import flash.events.*;
...
_playerConnection = new PlayerConnection( );
_playerConnection.addEventListener(PlayerConnection.PLAY_BROADCAST,

handlePlayerStreaing);

_playerConnection.addEventListener(PlayerConnection.STOP_BROADCAST,

handlePlayerStopped);

...
private function handlePlayerStreaming(e:Event):void {

// pause the first player's media stream to allow the second
// player's media stream to take priority

}
private function handlePlayerStopped(e:Event):void {

// unpause the first player's media stream, now that the second
// player's media stream has stopped

}

This ActionScript code first creates a new PlayerConnection object for receiving messages from a second media player. Next, two event listener functions are added, one for each type of event. The PlayerConnection object may generate an event at some unspecified time, for example when the function setStreamingStatus is called as a result of a command received from a second media player. This command may be sent using the LocalConnection mechanism described above. When the PlayerConnection object generates an event, an event handling function is called, depending on the type of event. Thus, for PLAY_BROADCAST events, function handlePlayerStreaming is called, while for STOP_BROADCAST events, function handlePlayerStopped is called. These functions may perform any appropriate action, including starting or stopping the media being played by the first media player 313 in a manner that coordinates with the second media player 333 so that only one media player is playing media at any given time.

The above code samples may be used on the first and second media players reciprocally. Thus, the second media player may listen to a LocalConnection, using the example binding name second_media_player, and the first media player may send it messages using process 342. The second media player may consider each message sent to be an event, and register event handlers in its various components. In this way, each media player may inform the other to start or stop playing the other's media, or perform any other function, such as checking whether the other player is currently connected to or playing media, adding media to the other player's play list, or adjusting the other player's volume. By using different binding names, any number of media players may communicate with each other in this fashion.

A media player in accordance with an embodiment of this invention need not be embedded in a web page. For example, a media player may be implemented so that it operates in a standalone Flash player, or as a standalone Java application. The LocalConnection functionality described above works between two embedded media players, as well as between an embedded media player and a standalone player, as well as between two standalone players. It also allows several other media players to connect to a single, named LocalConnection, so that the media players may send messages to the bound player. Socket connection interfaces in other languages provide similar functionality, and are within the scope of this invention.

If several prior art media players are present and playing media on the same client computer at the same time, the audio from the several media players may overlap, leading to an unpleasant experience for listeners. However, media players in accordance with embodiments of this invention may advantageously coordinate between themselves which player should be playing audio, by passing messages. If video data is also present in one or more of the media players, the players may coordinate between themselves whether and which media players should play video. In one embodiment, only the media player that is playing audio may also play video. In another embodiment, any media player that has video data may play the video, while muting any associated audio. In yet another embodiment, any media player that has video data without any associated audio may play the video. Media players that are not coordinated to play video may pause their video playback, or stop it entirely.

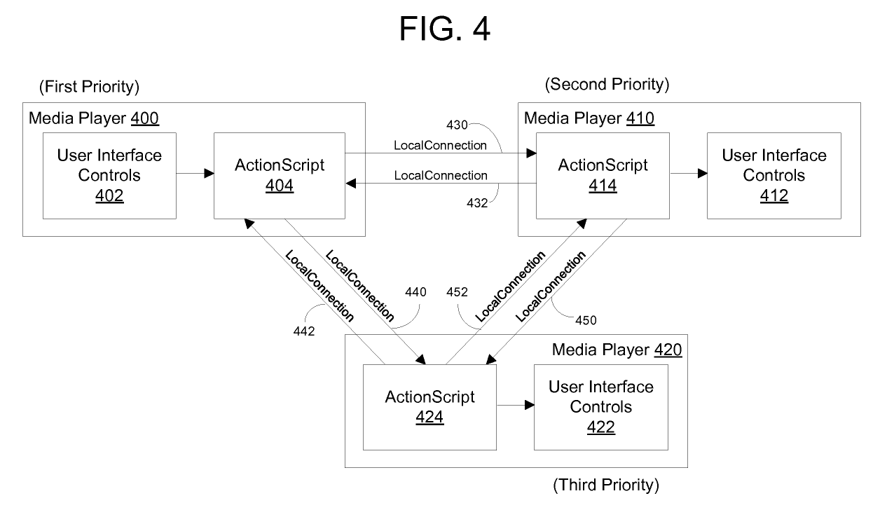

FIG. 4 is a block diagram showing three media players in one embodiment of the invention, indicating the priority among the players. Referring to the figure, the media players are labeled 400, 410, and 420 respectively. Each media player has user interface controls and ActionScript, as before. User interface controls 402 send messages to ActionScript 404, controls 412 send messages to ActionScript 414, and controls 422 send messages to ActionScript 424. Additionally, media player 400 may communicate with media players 410 and 420 via processes 430 and 440 respectively. Likewise, media player 410 may communicate with media players 400 and 420 via processes 432 and 450, and media player 420 may communicate with media players 400 and 410 via processes 442 and 452, respectively.

Each media player in FIG. 4 is labeled with a priority. Priority may be used by the media players to coordinate which player should be playing audio, video, or both at any given time. Thus, media player 400 has a first priority, media player 410 has a second priority, and media player 420 has a third priority. Any number of media players may be present and running on a client computer at any given time, and they may all have their own priority. In this example figure, the highest priority belongs to the third media player 420, so this media player may play its audio and video without interference from the other two media players 400 and 410. As noted above, in some embodiments other media players may play other media at the same time.

When a media player is newly opened, the user may expect that the media associated with that media player begin to play immediately. Thus, the newly open media player takes highest priority. The particular allocation of priorities shown in FIG. 4 may have arisen as a result of a user first opening media player 400, then media player 410, then opening media player 420. This priority allocation may have also arisen if the user selected a ‘play’ control in user interface controls 422 while another media player was playing. Although media player 420 may not be the most recently opened media player, it may be the one the user most recently interacted with, thus giving it highest priority. This situation may have also arisen if another media player stopped playing. If a fourth media player (not shown) having highest priority finished playing its media, the system may then locate the next highest priority media player and command it to resume playing its media. This media player may be media player 420.

Generally, to provide the best end user experience, a media player is assigned the highest priority when the user interacts with it. Thus, if the three media players depicted have their respective priorities, and the user interacts with the first media player 400, then this media player 400 takes on the (highest) priority 3. The remaining media players retain their priority ordering. As media player 420 had the highest previous priority, it now takes priority 2, and media player 410 takes first (lowest) priority. However, the invention is not limited to this restriction, and other embodiments may assign priorities based on criteria other than most recent user interaction. Other such criteria may include, for example, the passage of a certain amount of time, reaching a certain date or time, and receiving a computer message to alter a given media player's priority.

Priority may be established based on the fact that only one media player may bind a given name to a LocalConnection on a single client computer at any one time. Thus, each media player may attempt to bind a given, global name, such as media_player_1. If binding succeeds, then the binding player is the first media player to run on the client computer. If the binding fails, then another media player has bound a LocalConnection object to that name, so the binding player is not the first media player to run simultaneously. The subsequent media player may then send a message using the media_player_1 connection to establish communication with the first media player. This first media player may provide information about, for example, how many media players there are, their priorities, their bound names, and other useful information. Using this information, the subsequent media player may establish the proper number of LocalConnection objects to communicate with all of the other media players. In an alternate embodiment, binding names may be predictable, and a new media player may try them in order. For example, if a player fails to bind the name media_player_1 it can try media_player_2, and so on. When binding succeeds, the number of media players will have been determined. Once the communications network is in place, the media players may assign priorities amongst themselves.

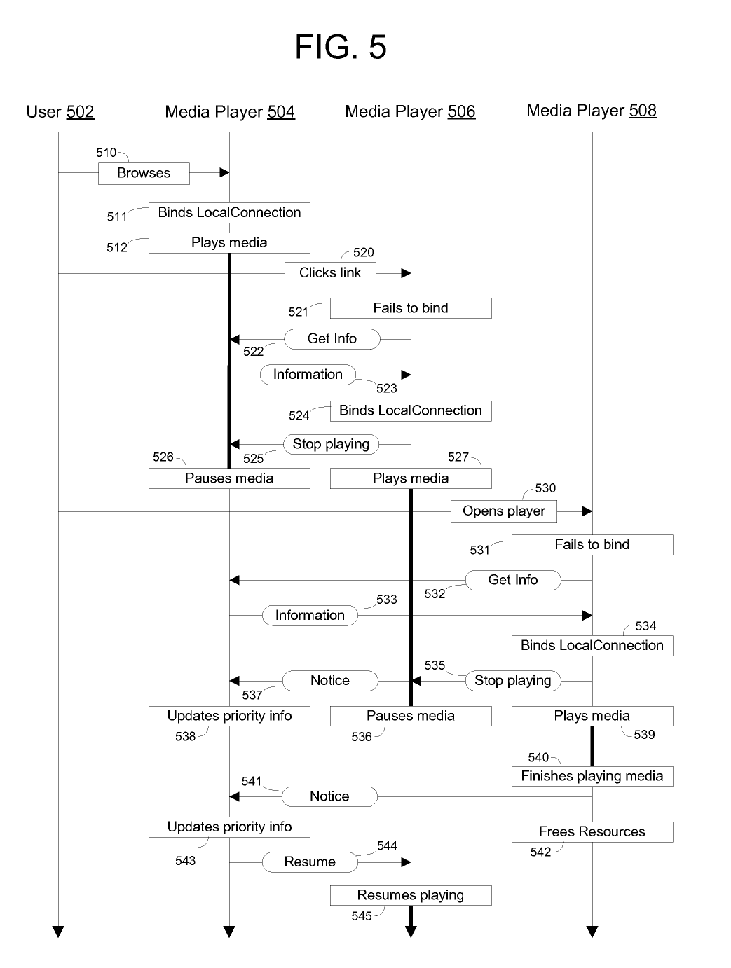

FIG. 5 shows a sequence diagram indicative of the media player priorities of FIG. 4. In process 510, a user 502 browses a web site to a page containing a first media player 504. First media player 504 attempts to bind a global name to a LocalConnection in process 511, and succeeds. Thus, because it was the first media player to be activated, first media player 504 receives priority 1, which is currently the highest priority. First media player 504 then begins to play its media in process 512.

While first media player 504 is playing, the user 502 clicks a link on the web page in process 520, thereby launching a second media player 506. Second media player 506 creates a LocalConnection and attempts to bind the same global name in process 521, but fails because first media player 504 has already bound that name. Thus, second media player 506 attempts to retrieve information from first media player 504 in process 522. Second media player 506 may access the LocalConnection of first media player 504 using the global name to which the latter is bound. First media player 504 returns information in process 523. This information may include data indicating that second media player 506 has received priority 2, the new highest priority. It may also include a name for the second media player to bind to. Or, in another embodiment, the second media player can construct a name using a pattern so that all binding names are predictable. Thus, in this other embodiment, if first media player 504 returns information that there are now two media players, second media player 506 may use the name media_player_2 to listen to incoming messages. In any case, second media player 506 may now bind a unique name to a LocalConnection in process 524 to await further messages from other media players.

At some later time, second media player 506 will begin to play media. However, before the media can be played, the first media player may be stopped. Thus, in process 525 second media player 506 sends a ‘stop playing’ message to first media player 504 using a LocalConnection. The first media player 504 may then become aware that another media player with higher priority wishes unimpeded access to the audio or video device, and in exemplary embodiments, may pause or stop playing in process 526. On or about the same time, second media player begins to play its own media in process 527. The change of active media players is shown in the figure using lines of heavy weight.

Next, in process 530 the user 502 opens a standalone third media player 508. Launching a standalone player may be done by activating a computer executable file for that purpose, or by other means known in the art. Third media player 508 undergoes a similar process to second media player 506 when starting. In process 531, third media player 508 attempts to bind a global name (such as media_player_1) to a LocalConnection object. Binding fails, as first media player 504 has already bound this name. So in process 532 third media player 508 requests information from first media player 504. This information will be similar to that returned to second media player in process 523, and may include data indicating that second media player 506 is currently playing. The information is returned to third media player 508 in process 533, so third media player 508 can bind a LocalConnection with its own unique name in process 534.

As described above, at a later time third media player 508 will begin to play media. Thus, in process 535 third media player 508 sends a ‘stop playing’ message to second media player 506. In response, second media player 506 may pause or stop playing its media. Additionally, third media player 508 may send a notice to first media player 504 in process 537, to inform first media player 504 that third media player 508 is assuming highest priority. At this time, first media player may update priority ranking information in process 538. On or about this time, third media player 508 may begin to play its media in process 539.

Some time later, third media player 508 reaches the end of its media and finish playing in process 540. At this time, third media player 508 may send a notice to first media player 504 in process 541, to inform first media player 504 that it has finished. Furthermore, third media player 508 may now free up its computing resources in process 542. This process may include freeing up memory so that the other media players or applications on the same client computer may use that memory. According to this embodiment of the invention, first media player 504 may now update its priority ranking information in process 543 to remove third media player 508. It then determines that second media player 506 has the highest remaining priority of the running media players, and sends a ‘resume’ message to second media player 506 in process 542. Second media player 506 then resumes playing in process 545, thus providing for nearly uninterrupted media playback.

In one embodiment of the invention, the first media player sends messages to all open media players after receiving requests for information from new players. For example, after process 532, first media player 504 may send a notice message to second media player 506, informing the latter that a third media player has joined. In this way, if the user closes first media player 504, second media player 506 may take over coordination functions for the system because it now has all of the priority data. In an alternate embodiment, a media player taking highest priority, for example as a result of user interaction, may send a message so indicating to all other media players in the system, informing them of the change in priorities. In another embodiment, any one of the media players may direct the others to pause or resume play, not just the first media player 504. In still another embodiment, the media players may coordinate amongst themselves in a distributed fashion, with no single media player acting as a central coordinator. Those skilled in the art may see other methods for intra-player communication that fall within the scope of the invention.

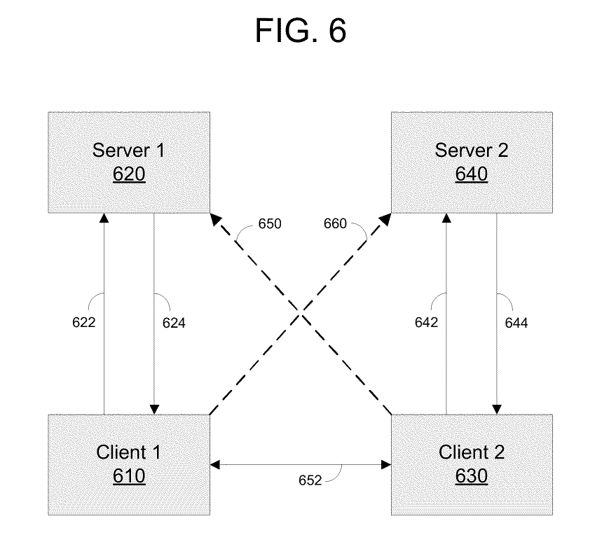

FIG. 6 is a block diagram of two client media players that are each retrieving media content from a different source (i.e. media servers). Other embodiments of the invention may have more client media players or media servers, and a media server may serve multiple clients. A user begins by directing a first client media player 610 to connect to a first media server 620. Typically, the client media player 610 will send a message to media server 620 using communications link 622, asking for data. The media server 620 responds by sending the requested data to client media player 610 using communications link 624. Similarly, a second client media player 630 may communicate with a second media server 640 using communications links 642, 644. First media player 610 may be, for example, a Flash player embedded in a web page, while second media player 620 may be, for example, a standalone Java media player, although it will be understood that other embodiments may be employed. For example, both media players may be stand alone media players, both media players may be embedded media players, and the media players may exist on separate devices, although in preferred embodiments they will be on the same device. If the media players are on separate devices, the devices may be located in physical proximity, and preferably within earshot of one another. The media players may be part of a stereo system, wherein a first media player is located within a stereo receiver and a second media player is located within a television for example. Further, first media player 610 may launch second media player 630 as a result of a user activating a control in media player 610, as described in connection with FIG. 3.

The two client media players 610, 630 may coordinate to control media servers 620, 640 by using each other as proxies. For example, in one situation first client media player 610 is playing audio when a user activates second client media player 630. In this case, the system may determine that second client media player 630 has priority to the user's audio and video experience, preferably using methods described above. First media player 610 may cease audio playback to avoid the user hearing overlapping sounds; however, first media server 620 may still be consuming bandwidth by sending audio data to media client 610 using communications link 624. As it is useful to conserve this bandwidth, in particular to use with communications link 644, second media player 630 may thus control first media server 620 to stop sending this audio data to first media player 610, as shown by arrow 650. Second client media player 630 may not have direct access to the functions of first media server 620 that control the data being sent on communications link 624. Thus, media player 630 may employ bidirectional communications 652 to control the media server using first client media player as a proxy. Control 650 may be accomplished by second client media player 630 directing first client media player 610 to direct first media server 620 to stop sending media data. Similarly, first client media player 610 may control second media server 640, as shown by arrow 660, using second client media player 630 as a proxy. In some embodiments, the second media player may communicate with the first media player to stop playback of media content. Responsive to this instruction to stop playback, the first media player will communicate with the first media server to stop streaming. Thus, the second media player indirectly controls the streaming of the first media server.

This proxy functionality is separate from the normal functioning of media players 610, 630, although by analogy one client media player may treat commands issued it by the other as if a user were directly controlling it. In one embodiment, first client media player 610 may treat a request from second client media player 630 to stop receiving data from first media server 620 as if the user had activated a STOP control. In another embodiment, the first client media player 610 may treat the request as if the user had activated a PAUSE control. In the former embodiment, the first client media player 610 may direct first media server 620 to stop sending data using communications link 624, while in the latter embodiment, the first client media player 610 may continue downloading the data to play at a later time. In an embodiment, second client media player 630 may be able to both kinds of functionality by sending different commands using bidirectional communications 652. The functionality described above may be implemented in some embodiments using direct remote procedure calls, as with the Flash LocalConnection functions.

In some embodiments, proxy functionality may be implemented as part of a separate and distinct communications protocol between media players. Such a protocol, which operates using bidirectional communications 652, may consist of different commands by which one media player may direct another to perform a function. Such functions may include, without limitation: play current media, pause media playback, stop media playback, begin downloading media, pause a download, resume a download, stop a download, adjust playback volume, select the next media in a playlist for playback, select the previous media in a playlist for playback, load a playlist, save a playlist, add media to a playlist, and remove media from a playlist.

This protocol may be used in conjunction with different media server capabilities. For example, a commercial media playing service providing media server 620 may have the capability to store media playlists for a user at a central location, so that the user may access her playlist from any suitable location. Using the protocol, second client media player 630 may add an entry on first media server 620 for the playlist of first client media player 610, even if second client media player 630 cannot play the entry due to, e.g., digital rights management (DRM) restrictions. The entry may be added at the direction of second client media player 630 because first media server 620 only receives a message from first client media player 610, which may meet the DRM criteria for adding the entry—the media server need not know that the request was not originally generated by that media player. Those skilled in the art will appreciate other uses for the communications protocol described herein that fall within the scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Flash, C, C++, Java, JavaScript, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

ActionScript™ and Flash® are trademarks of Adobe Systems Incorporated. Microsoft® and ActiveX® are trademarks of Microsoft Corporation. Java™ and JavaScript™ are trademarks of Sun Microsystems, Inc.

The present invention may be embodied in other specific forms without departing from the true scope of the invention. Any references to the “invention” are intended to refer to exemplary embodiments of the invention and should not be construed to refer to all embodiments of the invention unless the context otherwise requires. The described embodiments are to be considered in all respects only as illustrative and not restrictive. Numerous variations and modifications will be apparent to those skilled in the art. All such variations and modifications are intended to be within the scope of the present invention as defined in any appended claims.

What is claimed is:

1. A method for controlling media players operating on a computer system, the method comprising:
establishing an inter-process communication between a first media player and a second media player;
in the second media player, determining if the first media player is playing first media content using the inter-process communication;
if the first media player is playing the first media content, sending a command via the inter-process communication to the first media player to stop playing; and
starting playback of second media content on the second media player.

2. The method according to claim 1, further comprising:
in the first media player, after receiving the command from the second media player, stopping playback of the first media content.

3. The method according to claim 1, further comprising:
when the second media content stops playing, sending a begin playback command to begin playback of the first media content, from the second media player to the first media player via the inter-process connection.

4. The method according to claim 1, further comprising:
launching on the computer system the first media player;
starting playback of a first media content on the first media player, and
launching the second media player on the computer system.

5. The method according to claim 4, wherein launching the second media player occurs as the result of requesting a web page.

6. The method according to claim 5, wherein the second media player is embedded within the web page.

7. The method according to claim 4, wherein launching the second media player occurs as the result of user interaction with a web page.

8. The method according to claim 7, wherein the second media player is launched as the result of a script within the web page.

9. The method according to claim 8, wherein the script causes a container to be created, with the second media player being within the container.

10. The method according to claim 1, wherein the first media player is a stand-alone player.

11. The method according to claim 1, further comprising:
maintaining a priority among the media players; and
launching a third media player, the third media player:
establishing an inter-process communication with the first media player,
establishing an inter-process communication with the second media player, and
communicating with the first and the second media players through the connections to coordinate playback based upon the priority.

12. A computer program product comprising a tangible computer-readable medium for use with a computer system, the computer-readable medium having program code thereon for controlling playback of media content on a first media player, the computer code comprising:
computer code for establishing an inter-process communication with the first media player;
computer code for determining if the first media player is playing first media content;
computer code for sending a command via the inter-process communication to the first media player to stop playing if the first media player is playing the first media content; and
computer code for starting playback of a second media content.

13. The computer program product according to claim 12, further comprising:
computer code for sending a begin playback command to the first media player via the inter-process communication to begin playback of the first media content when the second media content stops playing.

14. The computer program product according to claim 13, wherein the first media player is embedded within a web page.

15. The computer program product according to claim 12, further comprising:
computer code for maintaining a priority among the media players; and
coordinating playback between the media players based upon the priority.

16. A system for controlling a media server, the system comprising:
a speaker;
a video display;
a first media player adapted to:
connect to the media server to control the reception of audio or visual data from the media server,
display audio or visual data retrieved from the media server on the speaker or video display, respectively, and
communicate with other media players using inter-process communication; and
a second media player adapted to:
display audio or visual data on the speaker or video display, respectively, and
communicate commands to the first media player, using inter-process communication, for directing the first media player to control the reception of audio or visual data from the media server.

17. The system according to claim 16, wherein the first media player is a standalone media player.

18. The system according to claim 16, wherein the first media player is embedded in a web browser displayed on the video display.

19. The system according to claim 16, wherein the second media player is a standalone media player.

20. The system according to claim 16, wherein the second media player is embedded in a web browser displayed on the video display.

21. The system according to claim 16, wherein the first media player is within a first computing device and the second media player is within a second computing device.

22. The system according to claim 16, wherein the first media player and the second media player are adapted to avoid simultaneous playback of audio on the speaker by communicating with each other using inter-process communication.

23. The system according to claim 16, wherein the first media player and the second media player are adapted to avoid simultaneous display of video data on the video display by communicating with each other using inter-process communication.

24. The system according to claim 16, wherein the reception of audio or visual data from the media server includes the reception of data according to a playlist, and the second media player is adapted to direct the first media player to select the next media in the playlist for playback, select the previous media in the playlist for playback, load the playlist, save the playlist, add media to the playlist, or remove media from the playlist.

25. The system according to claim 24, wherein the media server controls the playlist, and the second media player does not have permission to modify the playlist.

26. A method for controlling a media server, the method comprising:
in a first media player, connecting to the media server and requesting transmission of a stream of first media data;
in the first media player, receiving the stream of first media data and playing it;
in a second media player, using inter-process communication, sending the first media player a command to stop receiving the stream;
in the first media player, as a result of receiving the command, directing the media server to stop sending the stream; and
in the second media player, playing second media data.

27. The method according to claim 26, further comprising:
in the second media player, using inter-process communication, sending the first media player a second command to resume receiving the stream of first media data;
in the second media player, stopping the play of the second media data;
in the first media player, as a result of receiving the second command, connecting to the media server and requesting transmission of the stream of first media data; and
in the first media player, receiving the stream of first media data and playing it.

28. The method according to claim 27, wherein the second media player sends the second command in response to a user request.

29. The method according to claim 27, wherein the second media player sends the second command in response to reaching the end of the second media data during playback.

30. The method according to claim 27, wherein the second media player sends the second command in response to reaching a certain date or time during playback.
